(19) United States
(12) Patent Application Publication
(10) Pub. No.: US 2007/0048188 A1
(43) Pub. Date: Mar. 1, 2007

(54) Multi-channel pipette device

(76) Inventor: Hans Jürgen Bigus, Pliezhausen (DE)

Correspondence Address: PATENTANWAELTE LICHTI + PARTNER GBR, POSTFACH 41 07 60, D-76207, KARLSRUHE, DE

(21) Appl. No.: 10/572,849

(22) PCT Filed: Aug. 26, 2004
(86) PCT No.: PCT/EP04/09520

§ 371 Date: Mar. 22, 2006

(30) Foreign Application Priority Data
Sep. 26, 2003 (DE) 103 44 700.8

(51) Int. Cl. B01L 3/02

(52) U.S. Cl. 422/100

(57) ABSTRACT

A pipette device comprising a plurality of multi-channels which are arranged in one or several rows or like a matrix in several rows and columns and which are connected to the tip of a pipette on the end side thereof. At least one separate micromembrane pump is associated with each pipette channel for dosed suction or discharge of fluids, said pump consisting of several disk-type microstructures which are placed on top of each other and between which a pump chamber is formed and wherein one of which is provided with a membrane which can be deformed by an actuating element. In order to provide an extremely user-friendly pipette device which can be constructed in a simple, economical manner, at least some of the micromembrane pumps of different pipette channels are connected to each other in a material fit and the micromembrane pumps of each of said pipette channels can be programmed separately from each other by means of an electronic data processing unit such that the dosing volume of each micromembrane pump can be adjusted separately.

The invention concerns a pipette device comprising a dosing head with a plurality of pipette channels which are disposed in one or more rows or like a matrix in several rows and columns, and which can be connected to the tip of a pipette on the end side thereof, wherein each pipette channel has at least one associated, separate micromembrane pump for dosed suction and/or discharge of fluids, which is formed by several substantially disk-shaped microstructures which are disposed on top of each other and between at least two of which a pump chamber is formed, and at least one microstructure comprises the membrane which can be deformed by an actuating element. The invention also concerns a dosing head of a pipette device of this type and a computer program product for controlling such a pipette device.

Pipettes are widely used in laboratory technology for precise dosing of defined liquid volumes. Individual pipettes, having one pipette channel, are used as are multi-channel pipettes in large test series. They comprise a manual or motor-driven drive and generally have an adjustable volume. Fixed volume pipettes are also conventionally known.

Pipettes are operated either according to the direct displacement principle or via an intermediate air cushion. The first type is used, in particular, for dosing liquids with a high vapor pressure, high viscosity and high density. In addition to lifting piston pipettes, which are provided with a drive piston guided in a pipette channel within the pipette, pipettes operated with electrically driven micromembrane pumps have recently been more frequently used (EP 0 725 267 A2, EP 0 865 824 A1). They permit extremely precise dosing up to a dosing volume of a few nanometers (nm).

Multi-channel pipettes comprising a plurality of pipette channels disposed in one or more rows or like a matrix in several rows or columns are known in the art. The separation between the pipette channels or the pipette tips that can be disposed thereon, is generally standardized and, in particular, adjusted to the dimensions of the receptacles of standardized microtiter plates, which may e.g. be 9 mm for a standardized microtiter plate with 12 rows and 8 columns (altogether 96 receptacles), 4.5 mm for a plate with 16×24 (altogether 384 receptacles), and 2.25 mm for a plate with 32×48 (altogether 1536 receptacles).

There are also conventional multi-channel pipettes in the form of lifting piston pipettes, wherein the lifting pistons of the pipette channels have a common associated drive member to be able to dose the same fluid volume from all pipette channels. There are, however, multi-channel pipettes comprising a pump which is operatively connected to the pipette channels and can be programmed by a data processing means to permit automated dosing with predetermined fluid volumes. One particular disadvantage thereby is that only identical fluid volumes can be dosed from all pipette channels with the conventional multi-channel pipettes. The dosing volumes of multi-channel lifting piston pipettes can be varied by steps in the piston diameter or in the diameter of the pipette tips or pipette channels in which the lifting pistons are guided, but this does not allow individual adjustment of all dosing volumes and dosing of small volumes with such pipettes is limited.

EP 0 993 869 A2 describes a pipette device, wherein the pipette channel is operationally connected to two micromembrane pumps. One micromembrane pump is connected to the pipette channel on the pressure side and the other micromembrane pump is connected to the pipette channel on the suction side to ensure precise suctioning and dosing of media, irrespectively of each other, through corresponding activation of the respective pump. The document does not describe the precise control of the micromembrane pumps. It also proposes associating each channel with such a pump arrangement for a pipette device with several pipette channels, to be able to dose different dosing volumes independently of each other. This is, however, relatively demanding and expensive, in particular, due to the plurality of individual pump arrangements (two separate micromembrane pumps per pipette channel). Another reason is the complicated construction of such a pipette device, which requires individual provision of two micromembrane pumps for each pipette channel, wherein the separation between the pipette channels is fixed by the standardized separation between the receptacles of a microtiter plate.

Departing from the above-mentioned prior art, it is the underlying purpose of the invention to facilitate and reduce the expense for construction of a pipette device or a dosing head of such a pipette device and at the same time ensure straightforward operation. The invention also concerns a computer program product for controlling such a pipette device.

The first part of this object is achieved in a pipette device or a dosing head of such a pipette device in that at least some of the micromembrane pumps of different pipette channels are connected to each other in material fit and the micromembrane pumps of each pipette channel can be programmed separately from each other using an electronic data processing unit such that the dosing volume of each micromembrane pump can be separately adjusted.

The inventive design of the micromembrane pumps provides for extremely simple and inexpensive production of the pipette device compared to prior art, wherein the micromembrane pumps can be produced by manufacturing larger disks or plates (so-called “wafers”) of the microstructures forming the pumps, using so-called conventional microtechnical material shaping. The microstructures can be produced on the plates to form a membrane, valves, connections etc. in a conventional manner through thermal oxidation, photolithography, anisotropic shape etching etc.

The plurality of micromembrane pumps of the pipette channels, which, in accordance with the invention, are connected to each other in material fit and the microstructures associated with this plurality of pumps can be produced together in geometric, uniform arrangement, such that the process of separating the wafer section provided for the pump from its edge, serving as a holder during production, which is fundamentally required for production of micromembrane pumps, is not performed for each individual pump but for a common group of pumps. Since such micro technology separating processes require great precision, thereby maintaining the closest of tolerances, the costs of the overall pipette device can be considerably reduced by this improvement alone. Such a substrate thus contains the structures of a plurality of micromembrane pumps, wherein the separation of the shapes of the microstructures to be provided on the wafer can be adjusted to the desired separation between the pipette channels, in particular, the separation between the receptacles of a standardized microtiter plate, such that a plurality of micromembrane pumps is obtained which are connected to each other in material fit and which consist of common plates or wafers provided with microstructures, which can, however, be freely controlled, and, in particular, independently of each other, using individually programmed actuating elements. The installation of such units of micromembrane pumps in the pipette device is much simpler than in individual micromembrane pumps, since the pump unit, with pumps having a separation corresponding, in particular, to the hole separation of a microtiter plate, can be inserted together into the device and be commonly connected to the connecting channels of the pipette terminating in the pipette channels. Finally, the pump units can be interchangeably disposed in the pipette device, such that, in case of failure of only one micromembrane pump, the respective pump unit can be replaced. This interchangeability would be practically impossible with individual micromembrane pumps due to the plurality of individual connections to the respective pipette channels and the small space in the dosing head, wherein e.g. disposal of individual micromembrane pumps in a dosing head for a 32×48 microtiter plate could be realized only by injection molding of the pumps.

The inventive design of the multichannel pipette device also permits independent, individual adjustment of any dosing volume to any pipette channel, such that chemical, biological, biochemical or medical analyses and/or syntheses can be performed automatically, individually and simultaneously. The micromembrane pumps thereby ensure exact operation up to a dosing volume of a few nm. Since the pumps can be programmed independently of each other using the electronic data processing unit, the individual dosing volumes can be preset irrespective of each other. Compared to prior art, this permits pre-programming of the pumps and ensures extremely effective operation of the pipette device with less operating personnel.

Any conventional pump may be used for the micromembrane pumps of the pump units, wherein their substantially disk-shaped microstructures preferably consist of a semi-conductor material, in particular, of silicon or an alloy containing silicon.

The micromembrane pumps preferably comprise a piezoelectric, electromagnetic, electrostatic or thermopneumatic actuating element for driving their membrane. The thickness of such a silicon membrane is generally between approximately 10 and 200 μm, wherein the actuating element, e.g. a piezoelectrically actuatable actuator is directly disposed on the membrane.

In a preferred embodiment, at least the micromembrane pumps of the rows or columns of the matrix-like disposed pipette channels are connected to each other in material fit. Clearly, groups disposed in clusters or, in particular, all micromembrane pumps of the pipette device may also be connected to each other in material fit. While the latter design permits particularly inexpensive production of the pump arrangement, exchange of individual pump units is possible if several groups of one-piece micromembrane pumps are provided, and the rejects due to production errors, that may be produced during manufacture of the pump unit, can be reduced for a given plurality of micromembrane pumps used for the inventive dosing head.

While the micromembrane pumps of the pipette device can also basically be operated according to the direct displacement principle, in a preferred embodiment, an air cushion is provided between the fluid to be pipetted in the pipette channels and the at least one micromembrane pump associated with the respective pipette channel. As mentioned above, it is also of course feasible that the micromembrane pumps of the pipette device directly contact the medium to be supplied.

In a preferred embodiment, each pipette channel is associated with two micromembrane pumps which can be activated independently of each other and which have one connection on the suction side and one connection on the pressure side, wherein the pipette channel is connected to the connection of one micromembrane pump on the pressure side and to the connection of the other micromembrane pump on the suction side. In this design (known per se from an individual pipette according to EP 0 993 869 A2) the supply volume can be exactly adjusted for both the suction and dosing processes and can also be programmed separately by the data processing unit provided in accordance with the invention.

One micromembrane pump is thereby preferably connected to the surroundings on the pressure side and the other micromembrane pump is connected to the surroundings on the suction side, such that, if there is an air cushion in the pumps, only air is pumped, thereby preventing contamination of the pumps or, if pipette tips are used, of the pipette channels, by the fluid to be pipetted.

The connections of the micromembrane pumps on the pressure and suction sides are preferably provided with check valves to assure opposite flow directions in the two micromembrane pumps associated with each pipette channel.

In another preferred embodiment, each pipette channel is associated with a micromembrane pump having two openings that can be closed by two separately controlled valves, wherein the pipette channel is connected to one of the two openings. The supply volume can be exactly adjusted and, in particular, also programmed during both the suction and dosing processes through appropriate control of the valves.

The valves of the micromembrane pumps of a pipette device of this design suitably comprise a drive mechanism corresponding to the drive mechanism of the membrane, wherein e.g. piezoelectric actuating elements may be provided e.g. for the valves and also for the membrane.

The invention also concerns a computer program product for controlling a pipette device comprising a plurality of pipette channels which are disposed in one or more rows or like a matrix in several rows and columns and which can each be connected to one tip of a pipette on the end side thereof, wherein each pipette channel is associated with at least one separate micromembrane pump for dosed suction and/or discharge of fluids, with a user interface which permits input of an individual dosing volume for each pump or groups of pumps, wherein the program generates a signal for each dosing volume, that can be transmitted to a processor such that the processor drives each pump with the respectively input dosing volume. A computer program product of this type, which can be provided on any data carrier such as disks, CD-ROMs, hard disks etc., permits simple and convenient individual control of the plurality of micromembrane pumps and, in particular, pre-programming thereof, such that the pipette device can be operated for an even longer time, without operating personnel.

In a preferred embodiment, the user interface of the computer program product reproduces the pipette channels of the pipette device disposed in a row or rows or like a matrix in rows or columns, such that all pipette channels or only groups thereof can be visually reproduced on a display such as a monitor and the respectively desired individual dosing volume can be associated with each pipette channel, thereby largely avoiding operational errors.

The invention is explained in more detail below using embodiments with reference to the drawing.

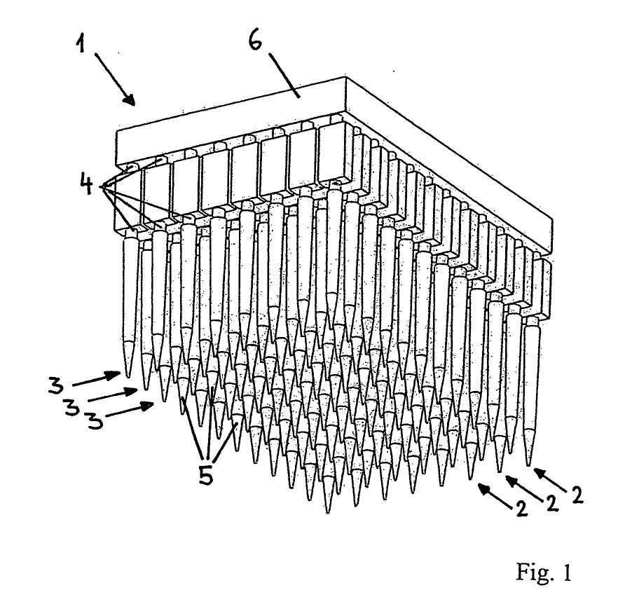

FIG. 1 shows a schematic view of a dosing head of a multi-channel pipette device with matrix-like pipette channels disposed in several rows and columns;

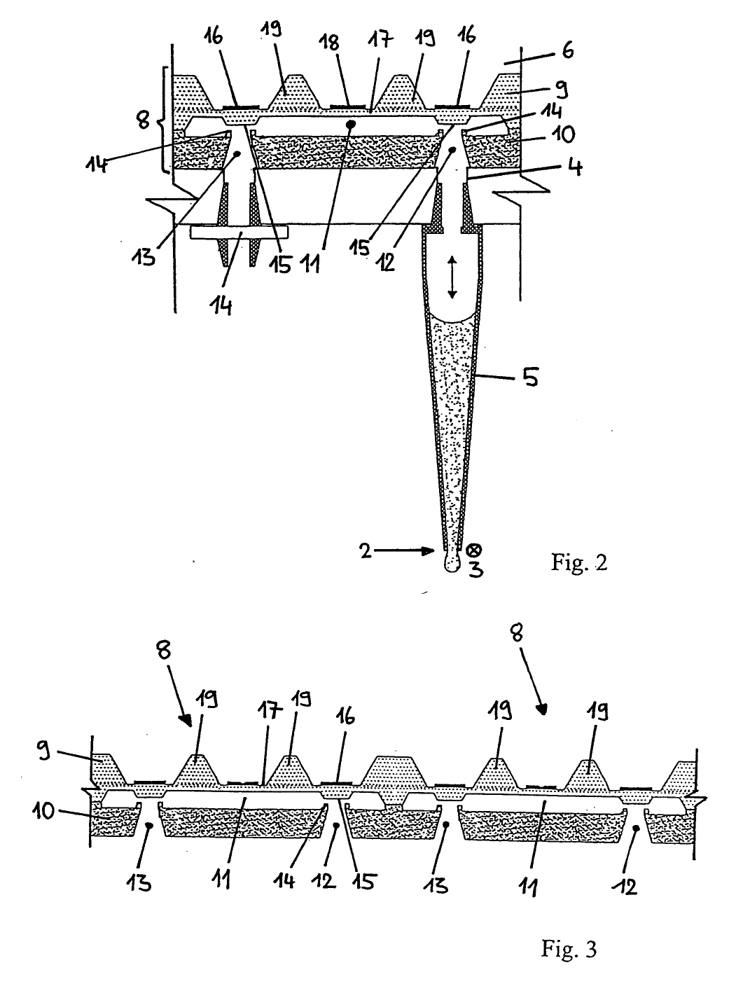

FIG. 2 shows a sectional detailed view of a pipette channel of the dosing head connected to a micromembrane pump in accordance with FIG. 1;

FIG. 3 shows a detailed view of the one-piece micromembrane pump of the dosing head in accordance with FIGS. 1 and 2; and

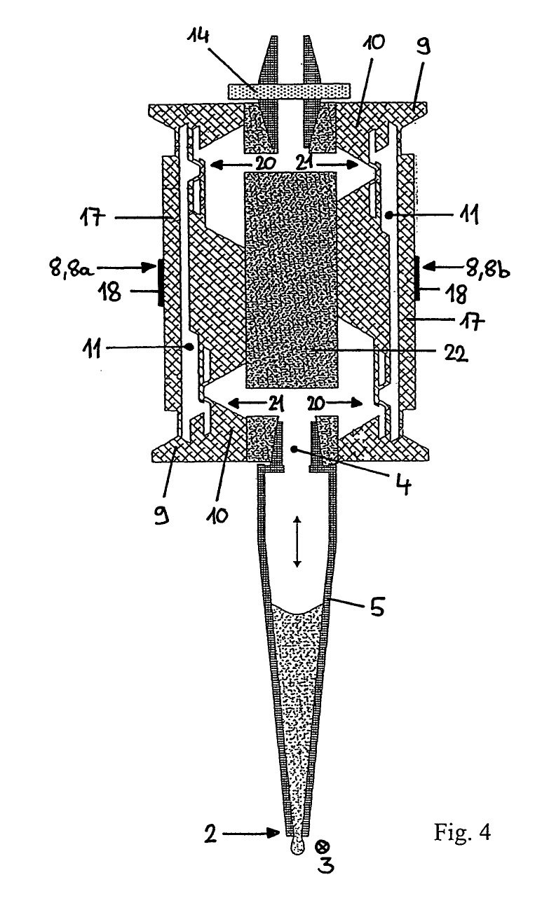

FIG. 4 shows a sectional detailed view of a pipette channel of an alternative embodiment of a dosing head of a multi-channel pipette device, connected to two micromembrane pumps.

The dosing head 1 of FIG. 1 of a pipette device (not shown) comprises a plurality of pipette channels 4 disposed like a matrix in several rows 2 and columns 3, with one pipette tip 5 being disposed on each working end thereof. The pipette tips 5 of the present embodiment are formed as disposable pipette tips and an air cushion is provided between the medium to be pipetted and the pipette channels 4. The separation between the pipette channels 4 and the pipette tips 5 corresponds, in particular, to the separation between the receptacles of a standardized microtiter plate.

The dosing head 1 is moreover provided with a substantially plate-shaped carrier 6 and the pipette channels 4 terminate on the lower side thereof facing the pipette tips 5. As explained below in detail with reference to FIGS. 2 and 3, the carrier 6 is provided with a number of micromembrane pumps 8, which are connected to each other in material fit (see FIG. 2ff) and which correspond to the number of pipette channels 4, wherein each pipette channel 4 is associated with a separate micromembrane pump and the micromembrane pumps can be programmed separately using an electronic data processing unit (not shown) to be able to separately adjust the dosing volume of each micromembrane pump.

The overall pipette device may moreover comprise a carriage (not shown) guided along a rail, to which the carrier 6 of the dosing head 1 is mounted and which can be moved in a controlled manner, in particular, using a data processing unit. The pipette device may also be associated with a holding device for adjusting the microtiter plates to perform simultaneous dosing processes in at least some receptacles of the microtiter plate using the dosing head 1.

FIG. 2 shows a sectional broken-off view of a micromembrane pump 8 that is connected to a pipette channel 4 of the pipette device, having a pipette tip 5. The micromembrane pump 8 of this embodiment has two substantially disk-shaped plates 9, 10, so-called wafers, which are produced e.g. from semi-conductor material, in particular, silicon or an alloy containing silicon. A pump chamber 11 is formed between the plates 9, 10, which is connected to the pipette channel 4 via a passage 12 in the lower plate 10 (FIG. 2), facing the pipette tip 5. In the present embodiment, an air cushion is provided between the passage 12 and the fluid to be dosed by the pipette tip 5. The pump chamber 11 is connected to the surroundings via a further passage 13 in the plate 10, wherein a filter 14 is interposed to prevent contamination.

In the region of the passages 12, 13, the lower plate 10 of FIG. 2 comprises peripheral beads 14 protruding in the direction of the pump chamber 11 and each forming one valve seat. Each valve is formed by one projection 15 on the side of the upper plate 9 facing the lower plate 10, which is substantially flush with the respective passage 12, 13. One actuator 16, e.g. in the form of a piezoelectric element, is disposed on each respective side of the upper plate 9 facing away from the lower plate 10, in the region of said projections 14, to individually open and close the valves 15. In this manner, the valves 15 of the passages 12, 13 can be separately opened or closed via separate actuators 16.

The membrane 17 of the micromembrane pump 8 is formed by a central section of the upper plate 9 which has a reduced cross-section compared to the edge sections of the plate 9 at which it is connected to the lower plate 10. On the side of the upper plate 9 facing away from the lower plate 10, a further actuator 17 is provided directly on the membrane 17 for actuating the membrane 17, and may be formed, like the actuators 16, e.g. by a piezoelectric element, such that the drive mechanism of the membrane 17 corresponds to that of the valves 15. Opening and closing of the valves 15 as well as actuation of the membrane 17 is effected though elastic deformation of the silicon material of the upper plate 9, in the region provided, by the respective corresponding actuator 16, 18. In order to stabilize the regions of the upper plate 9 disposed between the membrane 17 and the valves 15, these regions are reinforced by a thickening 19 disposed on the side of the plate 9 facing away from the pump chamber 11. This is also true for the connecting edge regions of the plates 9, 10.

All microstructures in the form of passages, projections, thickenings etc. in the cross-section of the plates 9, 10 may be produced after production of the plates 9, 10 through corresponding methods of microtechnical material shaping such as silicon shape etching, photolithography etc. The plates 9, 10 may thereby be produced separately and be connected to each other in their regions facing each other and surrounding the pump chamber 11 after fashioning the microstructures.

As can be seen in particular in FIG. 3, the rows 2 or columns 3 of pipette channels 4 of the pipette device (FIG. 1) or also all pipette channels have micromembrane pumps 8 which are connected to each other in material fit to facilitate production and reduce production costs. The upper plate 9 as well as the lower plate 10 of each row 2 or column 3 of micromembrane pumps 8 associated with pipette channels 4 are formed in one piece from one single wafer comprising the microstructures. Alternatively, all micromembrane pumps 8 or those arranged in a cluster may be formed from the common plates 9, 10. The separation between the passages 12 connected to the pipette channels 4 thereby suitably corresponds to the hole separation of a standardized microtiter plate. The thickenings 19 of the plate 9 disposed between the membrane 17 and the valves 15 decouple the respective membrane 17 from the valves 15 or individual membrane pumps 8 during operation of the micromembrane pumps 8 as do the correspondingly designed thickened regions between each pair of neighboring individual micromembrane pumps 8 of the pump unit, such that each membrane 17 or each valve 15 of each micromembrane pump 8 of the aggregate can be actuated separately and discretely using the actuators 16, 18.

All micromembrane pumps 8 of a pump unit formed in this manner can be programmed individually and separately using an electronic data processing unit, such that the dosing volume of each micromembrane pump 8 can be adjusted separately. Towards this end, a computer program product comprising a user interface is provided which permits input of an individual dosing volume for each pump 8 or groups of pumps 8, wherein the program generates a signal for each dosing volume, which can be transmitted to a processor (not shown) such that the processor individually drives each pump 8 with the correspondingly input dosing volume.

The operation of the micromembrane pumps 8 of the pump unit is described below:

In order to suction the fluid to be pipetted, the valve 15 associated with the passage 12 between the pump chamber 11 and the pipette channel 4 is closed, wherein the region of the upper plate 9 opposite the passage 12 is deformed through actuation of the actuator 16 in such a manner that the projection 15 sealingly abuts the peripheral bead 14. The pump chamber 11 is subsequently reduced in size through actuating the actuator 18 and through the associated deformation of the membrane 17. The valve 15 associated with the passage 13 between the pump chamber 11 and the outlet is correspondingly closed using the actuator 16, and the valve 15 associated with the passage 12 between the pump chamber 11 and the pipette channel 4 is then re-opened and the pump chamber 11 is enlarged again through switching off the actuator 18 to restore the membrane 17 shape, such that the fluid is suctioned into the pipette tip 5. This process is repeated until the desired dosing volume has been suctioned in.

The fluid is discharged from the pipette tip 5 in a corresponding manner through reverse actuation of the actuators 16. In this case, the valve 15 associated with the passage 13 between the pump chamber 11 and the outlet is closed, wherein, through actuation of the actuator 16, the region of the upper plate 9 opposite to the passage 13 is deformed in such a manner that the projection 15 sealingly abuts the peripheral bead 14. The pump chamber 11 is then reduced in size through actuating the actuator 18 or through the associated deformation of the membrane 17, whereby fluid is discharged from the pipette tip. The valve 15 associated with the passage 12 between the pump chamber 11 and the pipette channel 4 is then correspondingly closed by the actuator 16, and the valve 15 associated with the passage 13 between the pump chamber 11 and the outlet is then re-opened and the pump chamber 11 is enlarged again through switching off the actuator 18 to restore the shape of the membrane 17. This process is repeated until the desired dosing volume has been discharged.

FIG. 4 shows an alternative embodiment of a pipetting device, wherein each pipette channel 4 has two micromembrane pumps 8a, 8b which can be separately actuated. The micromembrane pumps 8a, 8b are formed in a similar manner as the micromembrane pumps 8 of the embodiment of FIGS. 2 and 3 from approximately disk-shaped plates 9, 10, which, in turn, consist e.g. of silicon or a silicon alloy. The pump chamber 11 of the micromembrane pump 8b formed between the plates 9, 10 is connected, at the pressure side connection 20, to the pipette channel 4 via an interposed air cushion, and the suction side connection 21 is connected to the surroundings through interposition of a filter 14. In contrast thereto, the suction side connection 21 of the micromembrane pump 8a chamber 11 is connected to the pipette channel 4 and the pressure side connection 20 is connected to the surroundings.

The membrane 17 of the micromembrane pumps 8a, 8b is formed by a central region of the plate 9, wherein this membrane 17 is thinner on its end side than in its central region, and maps at this end-side region into an end section of the plate 9, where the plate 9 is connected to the end section of the plate 10. The regions of reduced thickness make the membrane 17 more flexible upon actuation by an actuator 18 disposed on the side of the membrane facing away from the pump chamber 11. The actuator 18 may be formed by a piezoelectric element, analog to the embodiment of FIGS. 2 and 3. The connections of the micropumps 8a, 8b on the pressure 20 and suction 21 sides are formed by check valves to enforce opposite supply directions of the micromembrane pumps 8a, 8b. All microstructures formed on the plates 9, 10, such as the check valves, thickenings or taperings of the membrane 17 etc. may be fashioned on the plates 9, 10 e.g. using silicon shape etching. The thickened end sections of the plates 9, 10 thereby once more provide decoupling between micromembrane pumps 8a, 8b of a pump unit during operation through actuation via the respective actuators 18.

The present embodiment ensures simple and inexpensive construction of the pipette device in that the micromembrane pumps 8b which are disposed on the right hand side of the carrier 22 in FIG. 4 and which terminate in the pipette channel 4 at the pressure side connection 20, and the micromembrane pumps 8a which are disposed on the left hand side of the carrier 22 (FIG. 4) and which are connected via the pressure side connection 20 to the surroundings via the filter 14, of one column 3 of pipette channels 4 (see also FIG. 1) are connected in material fit by forming the silicon wafer 9, 10, from which the pumps 8a, 8b are made, from one single piece. Alternatively, the micromembrane pumps 8a, 8b of each row 2 of pipette channels 4 may of course be connected to each other in material fit. All micromembrane pumps 8a, 8b of one row 2 or column 3 of pipette channels 4 (FIG. 1) or all micromembrane pumps 8a, 8b of all pipette channels 4 of the pipette device may be formed by one-piece silicon plates 9, 10, wherein, in the two latter cases, two pumps may be disposed above one pipette channel 4, parallel to each other, and be connected via one pressure side connection and one suction side connection to the pipette channel 4, and to the surroundings, respectively (see FIG. 4). The separation between such pump pairs associated with each pipette channel 4 approximately corresponds to the hole separation of a microtiter plate.

In correspondence with the embodiment of FIGS. 2 and 3, all micromembrane pumps 8a, 8b of the pipette device shown in FIG. 4 can be programmed individually and separately using an electronic data processing unit to separately adjust the dosing volume of each micromembrane pump 8a for suctioning the fluid to be pipetted and the dosing volume of each micromembrane pump 8b for discharging the fluid to be pipetted. The individual dosing volumes are input using a computer program product with a user interface of the type mentioned above in connection with FIGS. 2 and 3.

The method of operation of the pipette device of FIG. 4 is described in more detail below.

In order to suction the fluid to be pipetted into the pipette tip 5 which is designed e.g. as one-way component, the actuator 18 of the micromembrane pump 8b on the left hand side of FIG. 4 is activated and the membrane 17 connected thereto is moved such that the volume of the pump chamber 11 increases. The fluid connected to the connection 21 of the micromembrane pump 8a on the suction side via the air cushion enters the pipette tip 5 due to the generated underpressure. The correspondingly switched check valves in the connections 20, 21 of the micromembrane pump 8a ensure that their suction side connection 21 is opened during this process, while their pressure side connection 20 is closed. In contrast thereto, the subsequent reduction in size of the pump chamber 11 of the micromembrane pump 8a caused by the actuator 18 to perform a further pumping process, ensures, by switching the check valves in the connections 20, 21, that the connection on the suction side connected to the pipette channel 4 is closed while the connection on the pressure side connected to the surroundings via the filter 14 is opened. This process is repeated until the desired dosing volume is reached.

The fluid is correspondingly discharged using the micromembrane pump 8b on the right hand side in FIG. 4. The membrane 17 of this pump 8b is caused to vibrate in an identical manner using the actuator 18, such that the volume of the pump chamber 11 is periodically increased or reduced in size. In contrast to the micromembrane pump 8a on the left hand side in FIG. 4, the check valves in the connections 20, 21 of the micromembrane pump 8b are switched in such a manner that the pressure side connection 20 of the pump 8a connected to the pipette channel 4 is opened in case of an overpressure in the pump chamber 11 and is closed in case of an underpressure, while the suction side connection 21 of this pump 8b connected to the surroundings is closed in case of overpressure in the pump chamber 11 and is opened in case of underpressure. The dosing volume can, in turn, be controlled via the number of lifting processes of the membrane 17, wherein each lifting motion is associated with a defined dosing volume, in particular, in the nanoliter range.

1-14. (canceled)

15. A pipette device for dosed suctioning and/or discharge of fluids through a plurality pipette tips, the device comprising:
a dosing head defining a plurality of pipette channels disposed in one or more rows or in a matrix of rows and columns, each channel for connection to one pipette tip;
a plurality of micro-membrane pumps, wherein at least some of said micro-membrane pumps are connected to each other in material fit, with each pipette channel cooperating with at least one micro-membrane pump for pumping and suctioning the fluids, the micro-membrane pumps comprising a first and a second substantially, disk-shaped member, disposed one on top of the other to define an intermediate pump chamber, wherein at least one of said first and said second disk-shaped members defines a membrane;
a plurality of actuating elements cooperating with said membranes to deform said membranes during pumping and/or suctioning; and
electronic data processing means communicating with said actuating elements to separately adjust a pumping volume of each membrane pump.

16. The pipette device of claim 15, wherein said substantially disk-shaped microstructures of said micro-membrane pumps comprise a semi-conductor material, silicon, or an alloy containing silicon.

17. The pipette device of claim 15, wherein said actuating elements comprise at least one piezoelectric, electromagnetic, electrostatic, or thermo-pneumatic drive means.

18. The pipette device of claim 15, wherein a group of said micro-membrane pumps in rows or columns or in a matrix are connected to each other with material fit.

19. The pipette device of claim 15, wherein all of said micro-membrane pumps are connected to each other in material fit.

20. The pipette device of claim 15, wherein an air cushion is provided between the fluid in a pipette channel and an associated micro-membrane pump.

21. The pipette device of claim 15, wherein each of said pipette channel has two associated said micro-membrane pumps which can be separately actuated and which have one connection on a suction side and one connection on a pressure side, wherein said pipette channel is connected to said pressure side connection of one said micro-membrane pump and said suction side connection of an other micro-membrane pump.

22. The pipette device of claim 21, wherein one of said micro-membrane pumps is connected to surroundings on said pressure side and said other micro-membrane pump is connected to surroundings on said suction side.

23. The pipette device of claim 21, wherein said pressure and suction side connections of said micro-membrane pumps comprise check valves.

24. The pipette device of claim 15, wherein each pipette channel has an associated micro-membrane pump having two openings which can be closed by two separately controlled valves, wherein said pipette channel is connected to one of said two openings.

25. The pipette device of claim 24, wherein said valves of said micro-membrane pumps have a drive mechanism that corresponds to a drive mechanism of said membrane.

26. The dosing head of the pipette device of claim 15.

27. A computer program product for controlling said electronic data processing means of claim 15, said data processing means having a user interface which permits input of individual dosing volumes for each pump or for groups of pumps, wherein the program generates a signal for each dosing volume which can be transmitted to a processor, such that the processor individually drives each pump with a respective input dosing volume.

28. The computer program product of claim 27, wherein said user interface reproduces said pipette channels of said dosing head of the pipette device disposed in a row or rows or like a matrix in rows and columns.
